(19) United States
(12) Patent Application Publication
(10) Pub. No.: US 2013/0291321 A1
(43) Pub. Date: Nov. 7, 2013

(54) Tube Squeegee

(71) Applicant: Bradley Scott Strahm, Sabetha, KS (US)

(72) Inventor: Bradley Scott Strahm, Sabetha, KS (US)

(73) Assignee: THE XIM GROUP, LLC, Sabehta, KS (US)

(21) Appl. No.: 13/888,402

(22) Filed: May 7, 2013

Related U.S. Application Data
(60) Provisional application No. 61/643,538, filed on May 7, 2012.

(51) Int. Cl. B08B 9/04

(52) U.S. Cl. CPC B08B 9/04
USPC 15/104.05

(57) ABSTRACT

The present invention provides a greatly improved method of squeegeeing a film of liquid from the inner surface of a transparent or semi-transparent tube after the liquid is drained from the tube so that the liquid level from a subsequent filling of the tube can be readily observed. In addition to removing the film of liquid, the present invention also provides a means to allow for overflow of the tube by allowing liquid to pass the squeegee device and reach an over-flow point located at the top of the tube. In addition, the present invention provides a means of sealing the entry point of the rod used to move the squeegee inside the tube so that liquid seed treatment does not leak out of the tube when it becomes filled. The features of the present invention maintain the closed nature of the system so that it is not required that the operator contacts the seed treatment liquid and that no spills or leaks occur.

### BACKGROUND OF THE INVENTION

The present disclosure is broadly concerned with a mechanical squeegee device for use in clearing liquid materials from the inside of a clear or translucent circular tube in order to aid the user in observing the liquid level in the tube after refilling.

The agriculture industry applies coatings called seed treatments to the exterior of seeds prior to planting them. These coatings contain substances that act as fungicides, insecticides, nematicides, growth boosters, fertilizers, inoculants, and the like that are beneficial to the young plant in the initial stages of germination and growth. These substances are often applied in a ratio to the seed as expressed as fluid ounces per weight of seed. In order to accurately apply the treatments in the proper ratio, the seed flow rate is controlled to a known rate and treatments are typically pumped onto the seed at the proper flow rate (fluid ounces per minute) to achieve the proper ratio of treatment to seed, then it is mixed in a horizontally oriented drum, and discharged to a receiving container. In order to achieve the proper flow rate (fluid ounces per minute), a calibration method is employed to either proper set the speed of the treatment delivery pump, or to calibrate an electronic volumetric flow meter so that it will accurately measure the treatment flow rate.

The aforementioned calibration method commonly employs a closed calibration system including a vertically oriented clear tube that is marked in ounces. Treatment materials are pumped into the tube for a known amount of time to determine the flow rate. This is used then to either set the speed of the pump, or to correct the flow meter reading in the case where a flow meter is used. In some cases the clear tube is also capped on the top end with an over flow tube secured into the cap that will direct any fluid reaching that point into a contained vessel. Thus if the tube is over filled, the treatment materials will be contained avoiding any contact with the equipment operator and any spills. Thus calibration systems have been designed where they are completely enclosed (a closed calibration system) providing an advantage over using graduated cylinders or pitchers in that they reduce the likelihood of operator contact with the treatment materials that are often hazardous.

One frustrating issue remains with closed calibration systems of this type is that the treatments tend to cling to the inner wall of the clear or translucent tube. The treatment materials are not translucent. Therefore, once the tube is filled, then drained, it is impossible or very difficult to be able to accurately observe the treatment level upon refilling due to the treatment materials from the previous fill still clinging to the interior wall of the tube. Some operators have resorted to cleaning the tube, but this typically requires that the tube be removed and washed, thus negating any benefits to having a closed calibration system because it exposes the operator to the treatment materials and provides opportunities for spills.

### DESCRIPTION OF THE RELATED ART

There are some devices currently known to those skilled in the art that serve to clean the interior wall of a clear or translucent tube. The most common device of this type is a syringe typically used in the medical industry that wipe the interior wall of the tube as the plunger is depressed.

In addition, a device called the “Swabbie Skimmer Neck Cleaner from Avast Marine Works (http://www.glassreef.com/review swabbie.php) uses a rotating action to clean the inside of a round tube using a squeegee attached to an arm that wipes the interior of the tube to clear it of debris.

### SUMMARY OF THE INVENTION

The present invention provides a greatly improved method of removing a film of liquid seed treatment from the inner surface of a transparent or semi-transparent tube after the liquid seed treatment is drained from the tube so that the liquid level from a subsequent filling of the tube can be readily observed. In addition to removing the film of liquid, the present invention also provides a means to allow for overflow of the tube by allowing liquid to pass the removal device and reach an over-flow point located at the top of the tube. In addition, the present invention provides a means of sealing the entry point of the actuating device into the tube so that liquid seed treatment does not leak out of the tube. The features of the present invention maintain the closed nature of the system so that it is not required that the operator contacts the seed treatment liquid and that no spills or leaks occur.

### BRIEF DESCRIPTION OF THE DRAWINGS

FIG. 1 is diagram illustrating the disclosed invention—a tube squeegee system.

FIG. 2 is a diagram illustrating a detailed view of the seal and overflow portion of the tube squeegee system

FIG. 3 is a diagram illustrating a detailed view of the squeegee portion of the tube squeegee system

### DETAILED DESCRIPTION

As required, a detailed embodiment of the tube squeegee invention is disclosed herein; however, it is to be understood that the disclosed embodiment is merely exemplary of the tube squeegee which may be embodied in various forms. Therefore, specific structural and functional details disclosed herein are not to be interpreted as limiting, but merely as a basis for claims and as a representative basis for teaching one skilled in the art to practice the invention in virtually any appropriately detailed structure.

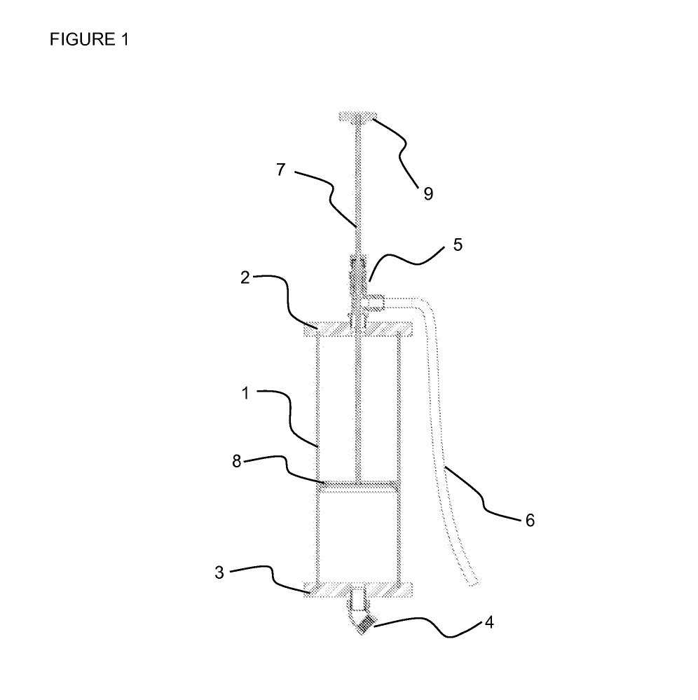

Referring now to the drawing figures, FIG. 1 illustrates a view of a tube squeegee embodiment of the present invention made of several components including a transparent or semi-transparent tube 1, capped on either end with caps 2 and 3. The lower cap as illustrated 3, has a fill and drain orifice 4, which is generally used for both filling and draining the tube. On the upper cap of the tube 2, there is an overflow seal assembly 5, which allows fluid in the tube to over flow into the over flow tube 6 when the tube is filled past the full point. The overflow seal assembly 5 also allows passage of the push rod 7 which is attached on the lower end to the squeegee ring 8. Therefore the user can grasp the knob 9 located at the top of the push rod 7 and move thereby move the squeegee ring 8. The squeegee ring 8 fits tightly inside the transparent or semi-transparent tube 1 and when it is moved by the operator, any liquid clinging to the inside of the tube 1 is wiped from the inside of the tube.

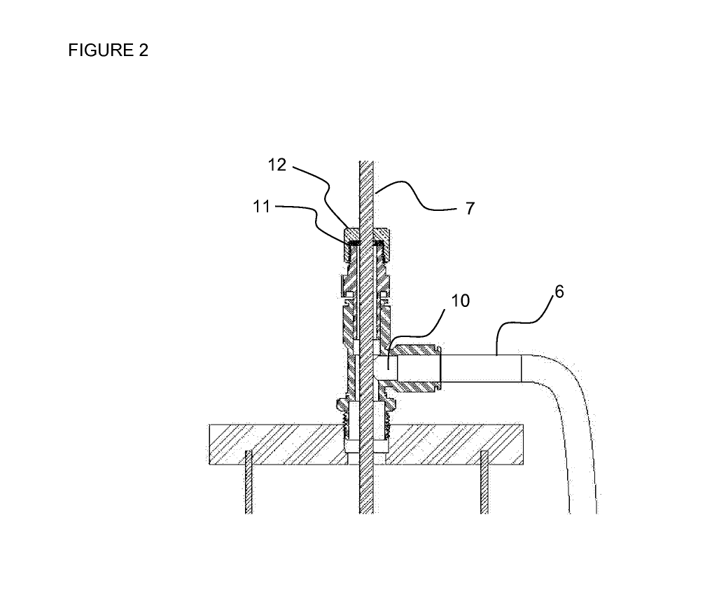

FIG. 2 illustrates a more detailed view of the overflow seal portion of the present invention. The overflow seal portion of the system allows fluid to flow past the push rod 7 through a passage 10 into the overflow tube 6. Where the push rod 7 passes through the upper portion of the overflow seal assembly, there is a rubber washer type seal 11 which is secured by a cap retaining device 12. This assembly allows the push rod 7 to slide through the overflow seal assembly while allowing overflow fluid to pass into the overflow tube 6 without leaking round the push rod 7 as prevented by the rubber washer seal 11.

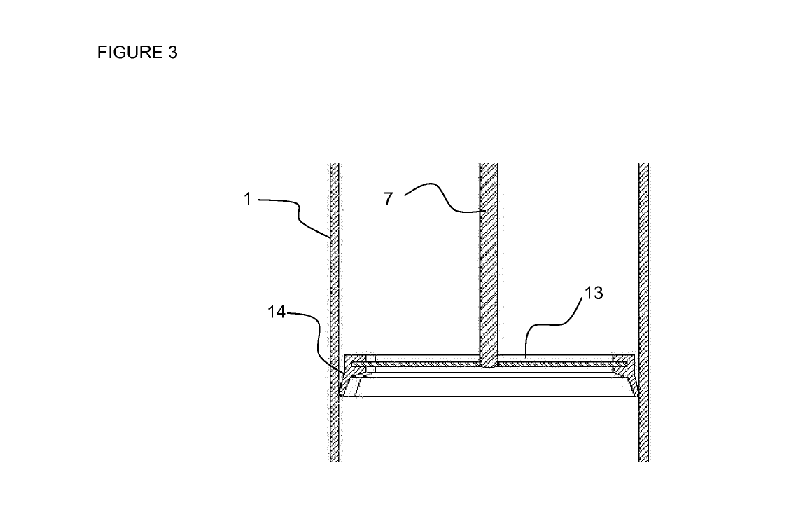

FIG. 3 illustrates a more detailed view of the squeegee or wiping portion of the present invention. The squeegee portion of the system includes a disc 13 that is attached to the push rod 7. The disc has openings in it (not visible in the drawing) that allows fluid to pass through the disc in the event that the fluid level gets higher than the position of the disc during the filling cycle and allows fluid to drain past the disc in the event that it gets above the disc. Around the outer edge of the disc 12, is a strip of flexible seal material 14 that wipes fluid off of the inner wall of the tube 1 as the disc 13 is moved by moving the push rod 7. The flexible seal material is preferably made of silicone rubber or some material with similar properties. It must fit snugly enough into the tube to effectively wipe the wall, but not so tight that it cannot be reasonably easily moved by actuating the rod.

I claim:

1. A tube squeegee apparatus to wipe liquid off of the interior wall of a tube, comprising:
a tube wiping assembly oriented substantially perpendicular to the axis of said tube and which allows liquid in the tube to pass said tube wiping assembly,
an actuating device oriented substantially parallel to the axis of said tube and attached to said tube wiping assembly and said actuating device extends to the exterior of the tube,
wherein said actuating device can be actuated from outside the tube to move said tube wiping assembly linearly along the length of the tube thus wiping liquid off of the interior wall of the tube.

2. The tube squeegee apparatus of claim 1 where said tube wiping assembly is comprised of:
a ring-shaped strip of flexible squeegee material which fits against said interior wall of said tube,
a disc having one or more openings to allow for the passage of liquid past said disc,
wherein said ring-shaped strip of flexible squeegee material is attached to said disc.

3. The tube squeegee device of claim 1 where:
said actuating device is a rod,
said tube squeegee apparatus includes a seal assembly at the point where said rod passes to the exterior of said tube where said seal assembly prevents passage of liquid around said rod at the location where said rod passes to the exterior of said tube.

4. The tube squeegee device of claim 3 where said seal assembly is comprised of:
a flexible washer which fits tightly against said rod, and
said flexible washer is held in place with a cap retaining device where said cap retaining device has an opening allowing for the passage of said rod.

5. The tube squeegee device of claim 2 where:
said actuating device is a rod,
said tube squeegee apparatus includes a seal assembly at the point where said rod passes to the exterior of said tube where said seal assembly prevents passage of liquid around said rod at the location where said rod passes to the exterior of said tube.

6. The tube squeegee device of claim 5 where said seal assembly is comprised of:
a flexible washer which fits tightly against said rod, and
said flexible washer is held in place with a cap retaining device where said cap retaining device has an opening allowing for the passage of said rod.
